(19) United States
(12) Patent Application Publication
(10) Pub. No.: US 2016/0146976 A1
(43) Pub. Date: May 26, 2016

(54) SUBSTRATE WITH MOTH EYE STRUCTURES AND METHOD OF MANUFACTURING THEREOF

(71) Applicant: ASUSTeK Computer Inc., Taipei (TW)

(72) Inventor: Wen-Chang Hung, Taipei (TW)

(21) Appl. No.: 14/841,006

(22) Filed: Aug. 31, 2015

(30) Foreign Application Priority Data
Nov. 25, 2014 (TW) 103140777

(51) Int. Cl. G02B 1/118; G02B 1/12

(52) U.S. Cl. CPC G02B 1/118; G02B 1/12

(57) ABSTRACT

A substrate with moth eye structures and a method of manufacturing thereof are provided. The method includes: providing a substrate including a first surface and a second surface, and forming a plurality of moth eye structures on the first surface. Since the moth eye structures are integrally formed on the substrate, the moth eye structures and the substrate include the same hardness. The reflected light is offset through the graded refraction via the moth eye structures, and the transmittance of the substrate is improved.

### CROSS-REFERENCE TO RELATED APPLICATION

This application claims the priority benefit of TW application serial No. 103140777, filed on Nov. 25, 2014. The entirety of the above-mentioned patent applications is hereby incorporated by reference herein and made a part of specification.

### BACKGROUND OF THE INVENTION

1. Field of the Invention

The invention relates to a substrate and, more particularly, to a substrate with moth eye structures and a method of manufacturing thereof.

2. Description of the Related Art

Conventionally, a light transmissive substrate with a high transmittance and a low reflection is used as a surface layer of a display, which reduces reflection of surrounding light during viewing contents on the display under brighter ambient lighting. Currently, a refractive index of a common glass substrate is too low to maintain the readability, visibility and picture quality for a display.

### BRIEF SUMMARY OF THE INVENTION

A substrate with moth eye structures and a method of manufacturing thereof are provided, and the moth eye structures with a lower wear rate are touch-resisting, which are applied to a touch surface of a touch display panel.

The method of manufacturing the substrate with moth eye structures includes the following steps: providing a substrate which having a first surface and a second surface; and forming a plurality of moth eye structures on the first surface.

In an embodiment, the moth eye structures are formed by etching the substrate. The moth eye structures brings the hardness to the touch surface of the touch display panel, and the touch display panel is not easily worn out by frequently touching thereon, and thus the anti-reflection effect is improved.

In addition, the substrate with the moth eye structures includes the first surface and the second surface, the first surface includes a plurality of moth eye structures, and the substrate and the moth eye structure are integrated formed.

As described above, the material of the moth eye structures and that of the substrate are the same, and thus the moth eye structures and the substrate have the same hardness.

### BRIEF DESCRIPTION OF THE DRAWINGS

These and other features, aspects and advantages of the disclosure will become better understood with regard to the following embodiments and accompanying drawings.

FIG. 1 is a flow chart showing a method of manufacturing a substrate with moth eye structures in an embodiment;

FIG. 2 is a flow chart showing a method of manufacturing a substrate with moth eye structures in an embodiment;

FIG. 3 is a side-sectional view showing a substrate in the first embodiment;

FIG. 4 is a side-sectional view showing a substrate in the second embodiment;

FIG. 5 is a stereogram showing concave moth eye structures in an embodiment;

FIG. 6 is a stereogram showing convex moth eye structures in an embodiment;

FIG. 7 is a side-sectional view showing a substrate in a third embodiment;

FIG. 8 is a side-sectional view showing a substrate in a fourth embodiment;

FIG. 9 is a schematic diagram showing an arrangement of moth eye structures in the first embodiment;

FIG. 10 is a schematic diagram showing an arrangement of moth eye structures in the second embodiment;

FIG. 11 is a stereogram showing convex moth eye structures of the substrate in the first embodiment;

FIG. 12 is a stereogram showing convex moth eye structures of the substrate in the second embodiment;

FIG. 13 is a stereogram showing convex moth eye structures of the substrate in the third embodiment;

FIG. 14 is a stereogram showing convex moth eye structures of the substrate in the fourth embodiment; and

FIG. 15 a schematic diagram showing a way that moth eye structures of a substrate represent data in an embodiment.

### DETAILED DESCRIPTION OF THE EMBODIMENTS

These and other features, aspects and advantages of the disclosure will become better understood with regard to the following embodiments and accompanying drawings.

A substrate with moth eye structures and a method of manufacturing thereof are provided. The method includes the following steps: providing a substrate including a first surface and a second surface; and forming a plurality of moth eye structures on the first surface.

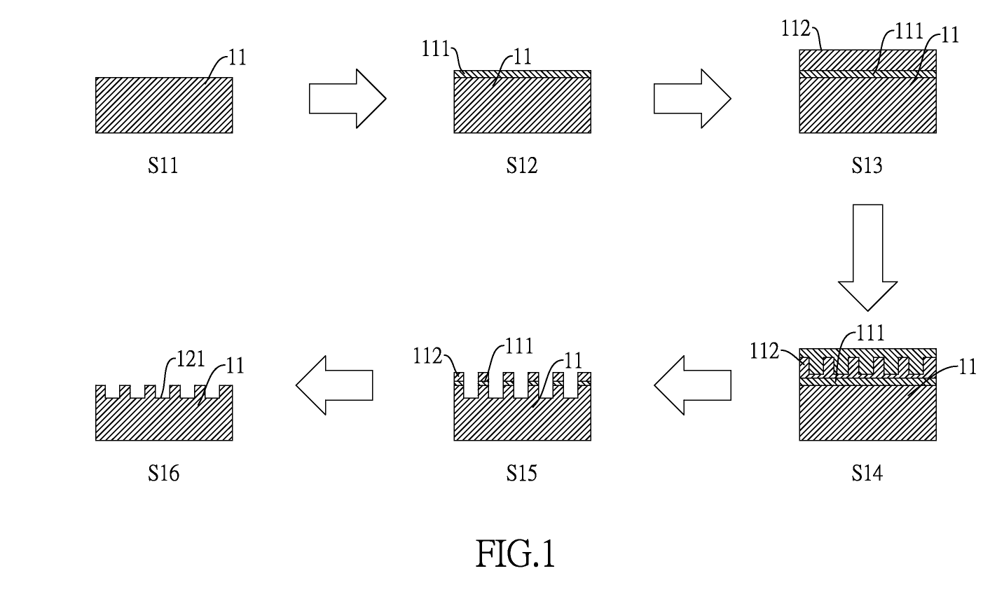

Please refer to FIG. 1, in a first embodiment, a method of manufacturing a substrate with moth eye structures includes the following steps: providing a substrate 11 (S11), and the substrate includes a first surface and a second surface; disposing a mask layer 111 on the first surface (S12); disposing a photoresist layer 112 on the mask layer 111 (S13); imprinting the photoresist layer 112 to generate a plurality of moth eye structure patterns on the photoresist layer 112 and exposing the moth eye structure patterns (S14); etching the first surface of the substrate 11, the etching at least reaches to the substrate 11 (S15); removing the photoresist layer 112 and the mask layer 111 (S16) from the substrate 11 to generate a plurality of moth eye structures 121 on the first surface.

According to the method of manufacturing the substrate, the moth eye structure patterns are imprinted on the photoresist layer 112 of the substrate 11 first, the first surface of the substrate 11 is at least etched to a depth, and then the substrate 11 is etched to generate a plurality of moth eye structures 121. Then, after the photoresist layer 112 and the mask layer 111 are removed, the moth eye structures 121 are formed on the substrate 11. Since the moth eye structures 121 are formed directly on the substrate 11, the material of the substrate 11 and that of the moth eye structures 121 are the same, and the substrate 11 and the moth eye structures 121 are integrated as the same component, the hardness and the abrasion resistance of the substrate 11 and those of the moth eye structures 121 are the same.

In an embodiment, the step of disposing the mask layer 111 (S12) on the first surface is omitted. In an embodiment, the photoresist layer 112 is directly disposed on the first surface, and the mask layer 111 is omitted. That means, the photoresist layer is imprinted directly to generate a plurality of moth eye structure patterns on the photoresist layer 112, and the moth eye structure patterns are further exposed (S14).

Consequently, when the substrate 11 is applied to a touch display panel, due to the high hardness and the high abrasion resistance of the moth eye structures 121, the moth eye structures 121 are used as a touch surface of the touch display panel directly, and the moth eye structures 121 are not easily worn by the touch thereon. In addition, the outside light is offset through graded refraction via the moth eye structures 121, and thus little reflected light is reflected out when the outside light illuminates on the substrate 11. Consequently, the display contents of the touch display panel are clearly shown to the users. Furthermore, since the substrate includes the moth eye structures 121, a color error is not easily generated at the touch display panel. Moreover, when the users touch on the touch surface of the touch display panel, a contacting area between the finger and the touch surface is reduced due to a plurality of small and uneven moth eye structures 121 on the touch surface, thus, the friction between the finger and the touch surface is reduced, and the touch surface feels more smooth.

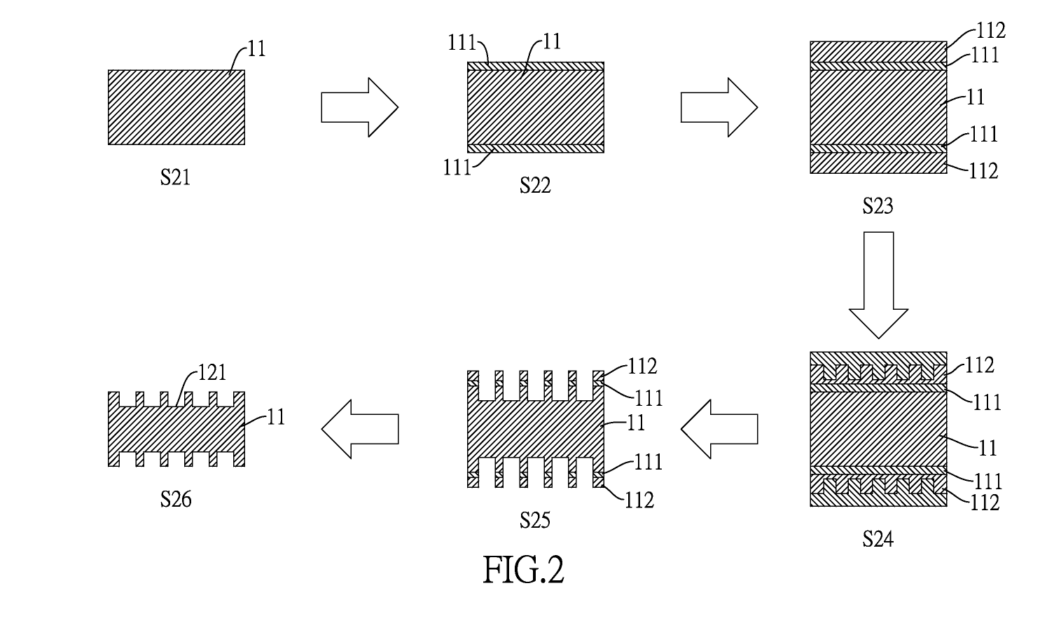

Further, please refer to FIG. 2, in a second embodiment, a method of manufacturing the substrate with the moth eye structures includes the following steps: providing the substrate 11 (S21); disposing the mask layers 111 on the first surface and the opposite second surface of the substrate 11, respectively (S22); disposing the photoresist layer 112 on the two mask layers 111, respectively (S23); imprinting the two photoresist layers 112, respectively, to generate a plurality of moth eye structure patterns on the photoresist layers 112 and exposing the moth eye structure patterns (S24); etching the first surface and the opposite second surface of the substrate by a depth at least to the substrate 11 (S25); removing the photoresist layers and the mask layers from the substrate 11 to form a plurality of moth eye structures on the first surface and the second surface, respectively (S26).

In the second embodiment, the moth eye structures 121 are formed on the first surface and the opposite second surface of the substrate 11, respectively, and thus the anti-reflection property and the light transmittance of the substrate 11 are increased. In the embodiment, when the touch display panel utilizes the substrate 11 as the touch surface, the first surface and the opposite second surface of the substrate 11 with the moth eye structures 121 are regarded as an in-light surface and an out-light surface of the touch display panel, respectively. The out-light surface is the touch surface of the touch display panel, the moth eye structures 121 formed on the out-light surface offset the light illuminated on the out-light surface via the graded refraction, and thus the outside light to reflect to the eyes of the users is reduced. As a result, an interference of the outside light is reduced, and the contents of the touch display panel can be seen clearly. The moth eye structures 121 formed on the in-light surface reduced reflection of backlight illuminated on the in-light surface of the touch display panel, and thus the transmittance of the backlight out the substrate 11 is increased, and then the users feel much comfortable in watching.

In the first embodiment and the second embodiment, the substrate 11 is transparent, the Moh's hardness of the substrate 11 equals to or is larger than eight. In an embodiment, the substrate 11 is a transparent substrate with aluminium oxide (AlₘOₙ), wherein m, n are natural numbers, such as a sapphire (Al₂O₃) substrate a magnesium aluminate (MgAl₂O₄) crystallization substrate or an aluminium oxynitride (AlON) substrate, which is not limited herein. The substrate is a plane lens substrate, a convex lens substrate, a concave lens substrate, a concave-concave lens substrate, a concave-convex lens substrate or a convex-convex lens substrate, which is not limited herein. The material of the mask layer is silicon dioxide (SiO₂) or nickel oxide (NiO), or other masking materials, which is not limited herein.

In an embodiment, the imprinting method is a nanoimprint lithography (NIL) method, or the photo process by exposing and developing the moth eye structure patterns on the photoresist layer. In addition, the size of the moth eye structure patterns is in nanometer level, and the sizes of the moth eye structure patterns are determined by the imprinting method. In an embodiment, the sizes of the moth eye structure patterns imprinted by the NIL method are between 200 nm and 300 nm, which is not limited herein.

In an embodiment, the moth eye structures 121 are formed by engraving the first surface or the second surface via the laser. The laser engraving is also adapted to engrave the moth eye structures on the substrate 11 with curved surfaces. In an embodiment, the etching method is a dry etching method, a wet etching method, or an inductively coupled plasma etching (ICP etching) method, which is not limited herein.

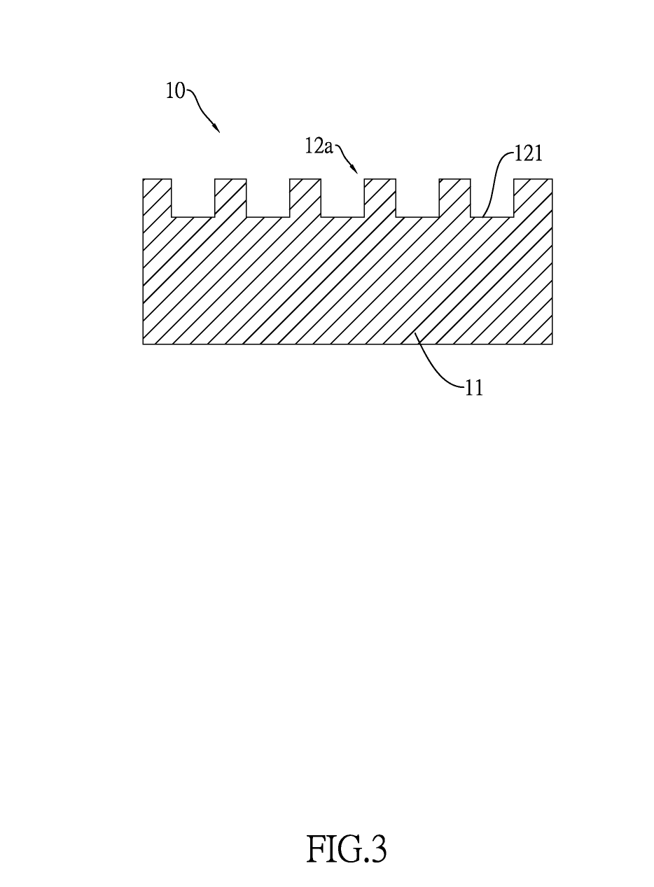

Please refer to FIG. 3, the substrate 10 with the moth eye structures is manufactured by the method of the first embodiment. The substrate 10 includes the substrate 11 and a first moth eye portion 12a, the first moth eye portion 12a includes a plurality of moth eye structures 121 which are formed on the first surface of the substrate 11, and the moth eye structures 121 and the substrate 11 are integrally formed.

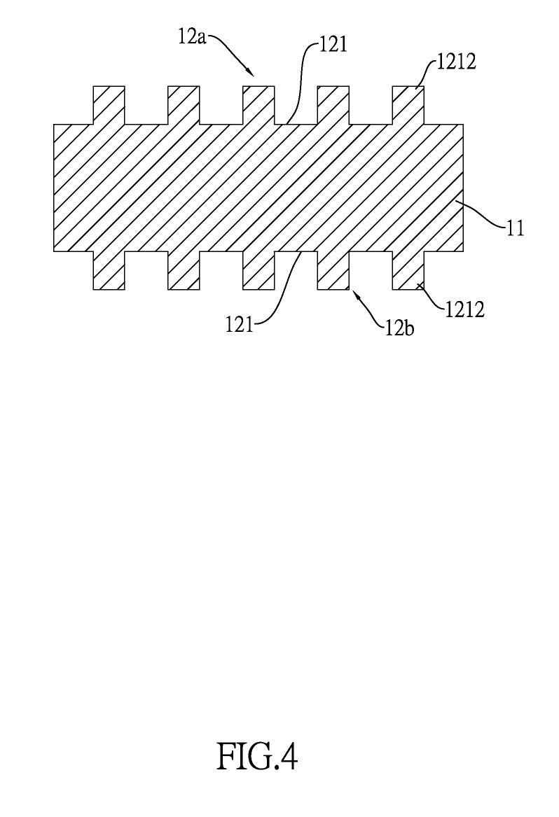

Please refer to FIG. 4, the substrate 10 with the moth eye structures is manufactured by the method of the second embodiment. In the second embodiment, a first moth eye portion 12a, a second moth eye portion 12b are formed on the first surface and the opposite second surface of the substrate 11, respectively, so as to further increase the anti-reflection property and the light transmittance of the substrate 10 with the moth eye structures, and then the reflected light of the outside light is offset via the graded refraction, and the transmittance of the substrate is increased. Moreover, since the first moth eye portion 12a, the second moth eye portion 12b and the substrate 11 are integrally formed, the hardness and the abrasion resistance thereof are the same which are greater than those of the photoresist layer 112 after exposing and hardening, and thus the abrasion resistance is improved.

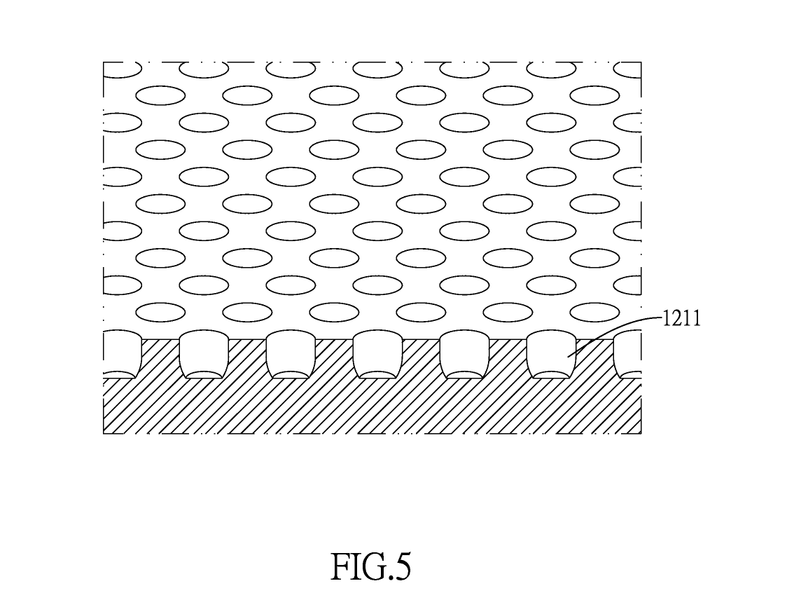

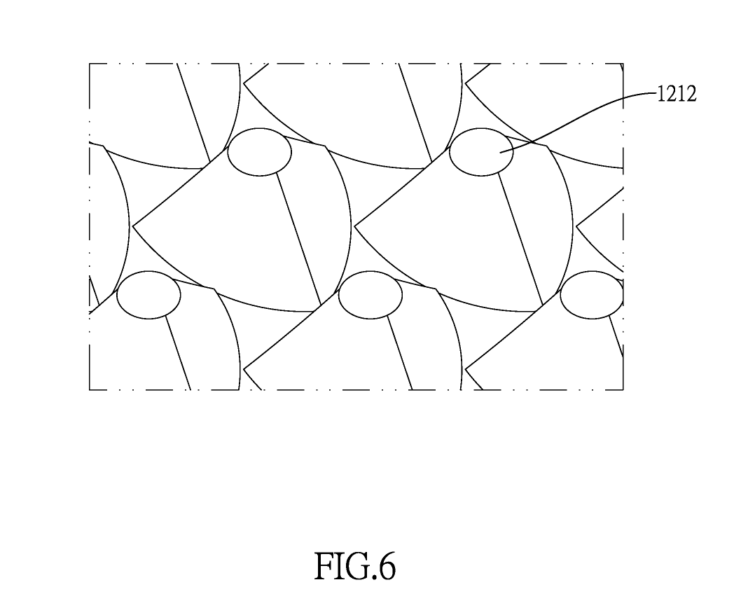

In an embodiment, please refer to FIG. 5 and FIG. 6, the moth eye structures 121 are concave moth eye structures 1211 as shown in FIG. 5 or convex moth eye structures 1212 as shown in FIG. 6. The concave moth eye structures 1211 are formed by imprinting predetermined patterns (such as circle patterns) on the first surface first, then the patterns indents to form concaves on the photoresist layer 12. Consequently, the photoresist layer 12 of the first surface imprinted with patterns is thinner than that without patterns. Then, since the photoresist layer 12 of different thickness include different resistance against the etching, the concave moth eye structures 1211 are formed. In contrast, the convex moth eye structures 1212 are formed by imprinting the area of the first surface except the area of the predetermined patterns, then, the photoresist layer 12 of the first surface imprinted with patterns is thicker than that without patterns. Since the thickness of the photoresist layer 12 of different thickness include different resistance against the etching, the convex moth eye structures 1212 are formed.

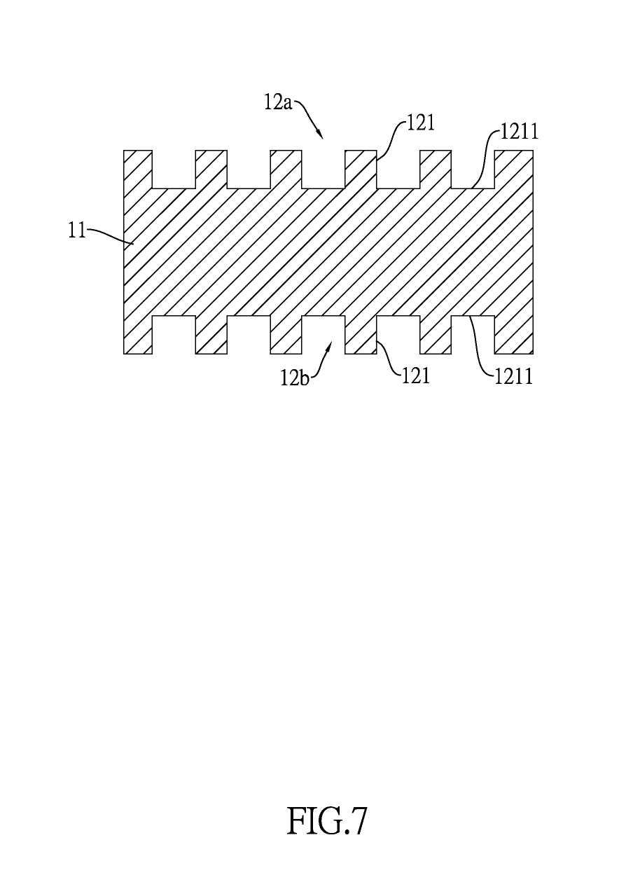

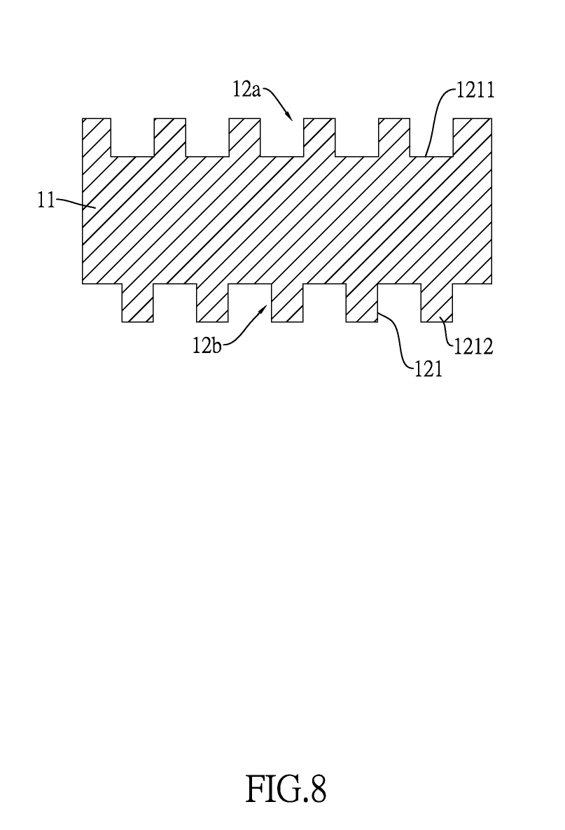

FIG. 4, FIG. 7 and FIG. 8 show the substrate 10 with the moth eye structures in a second embodiment to a fourth embodiment. As shown in FIG. 4, a plurality of moth eye structures 121 of the first moth eye portion 12a and that of the opposite second moth eye portion 12b formed on the substrate 11 are the convex moth eye structures 1212 and the convex moth eye structures 1212, respectively. As shown in FIG. 7, the moth eye structures 121 are the concave moth eye structures 1211 and the concave moth eye structures 1211 at opposite sides, respectively. As shown in FIG. 8, the moth eye structures 121 are the concave moth eye structures 1211 and the convex moth eye structures 1212 at opposite sides, respectively, which is not limited herein.

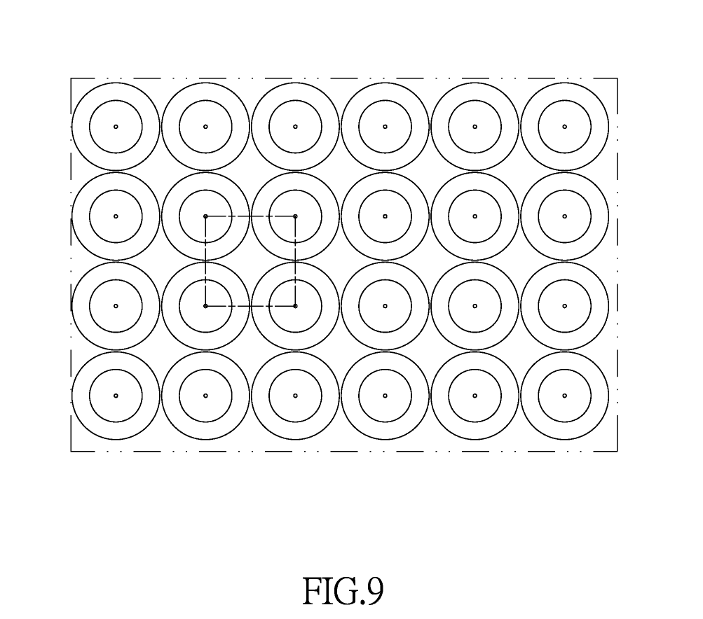

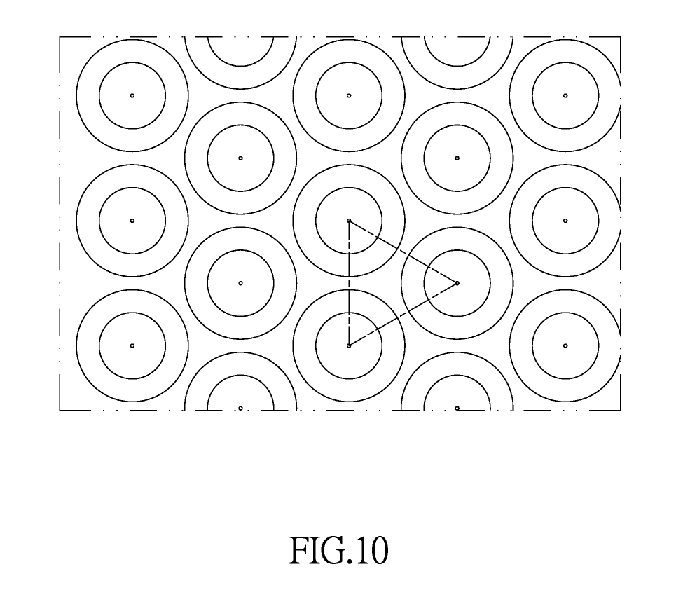

In an embodiment, please refer to FIG. 9 and FIG. 10, when the moth eye structures 121 are formed on the first surface or the second surface of the substrate 11, the moth eye structures 121 are arranged by a square arrangement or a dense arrangement, which is not limited herein. As shown in FIG. 9, in the square arrangement, the moth eye structures 121 are arranged in a matrix, and the adjacent moth eye structures 121 of any two adjacent columns are aligned, and then the centers of any four adjacent moth eye structures 121 as shown is a square in a top view. In the dense arrangement as shown in FIG. 10, the moth eye structures 121 are arranged in a matrix, and the adjacent moth eye structures 121 of any two adjacent columns as shown are staggered arranged, and then the centers of any three adjacent moth eye structures 121 as shown is a triangle in a top view, which is not limited herein.

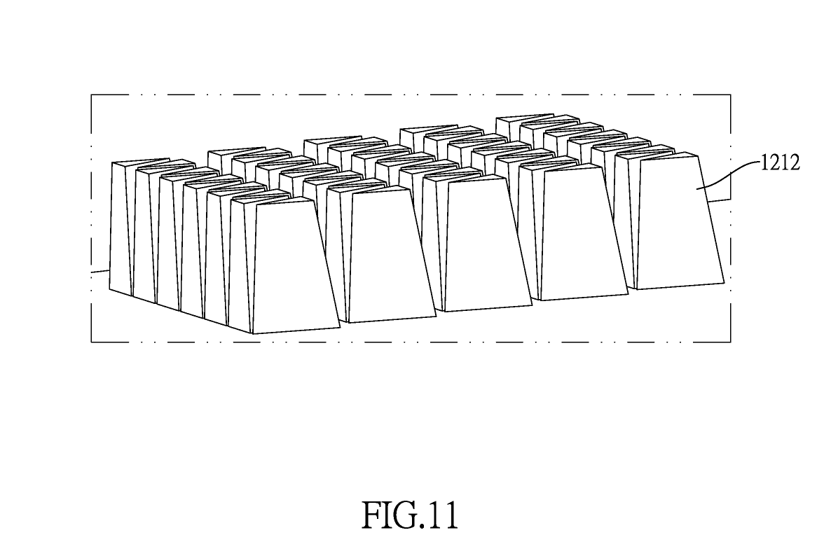

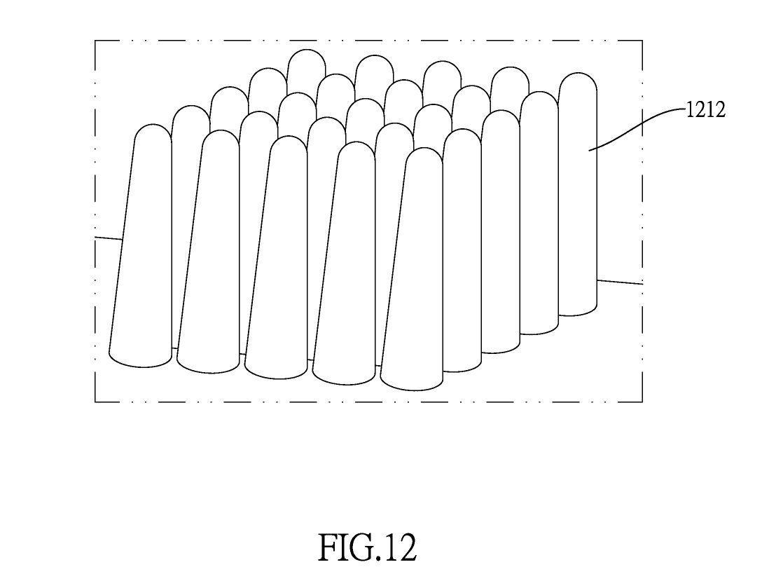

FIG. 11 to FIG. 14 show the convex moth eye structures 1212 in a first embodiment to a fourth embodiment. As shown in FIG. 11, in the first embodiment, the convex moth eye structures 1212 are triangular prism shaped in a dense arrangement. As shown in FIG. 12, in the second embodiment, the convex moth eye structures 1212 are cylinder shaped, and the arrangement of the cylinder shaped convex moth eye structures 1212 is the square arrangement or the dense arrangement, which is not limited herein.

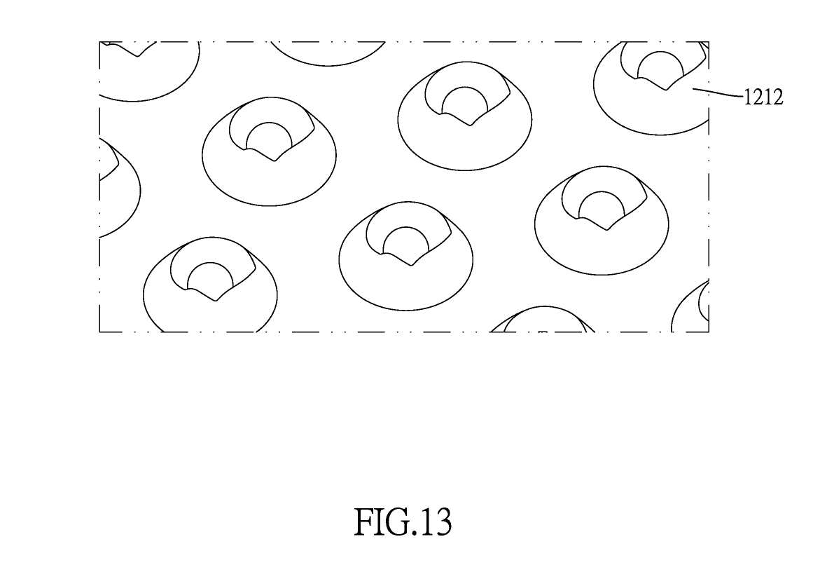

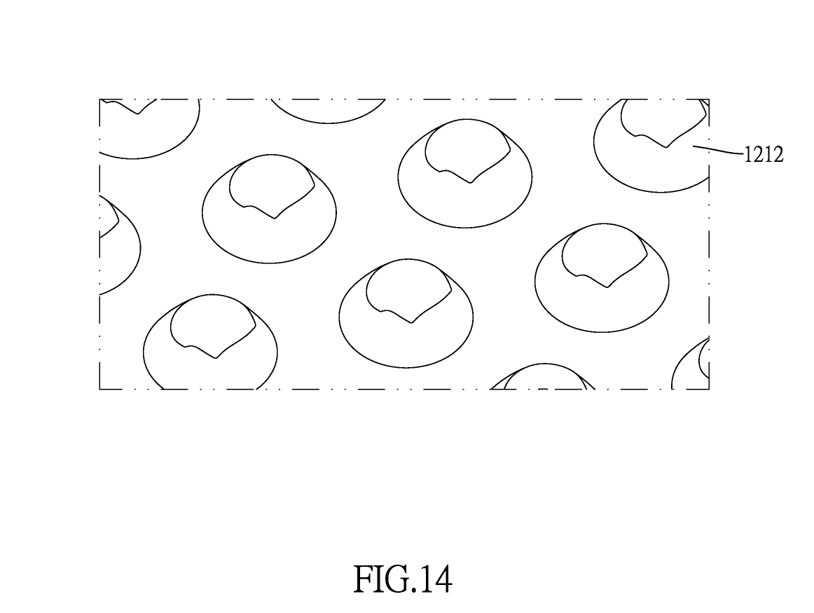

As shown in FIG. 13, in the third embodiment, the convex moth eye structures 1212 are semi-spherical shaped, and a cavity portion is formed on a top surface of the each convex moth eye structure 1212, a convex is formed at a bottom surface of the cavity portion, and then crown shaped convex moth eye structures 1212 are formed. Each moth eye structure 1212 is convex-concave-convex from the center to outside of the each convex moth eye structure 1212. As shown in FIG. 14, in the fourth embodiment, the convex moth eye structures 1212 are semi-spherical shaped, and a cavity portion is formed on a top surface of the each convex moth eye structures 1212, and then volcano shaped convex moth eye structures 1212 are formed, and each convex moth eye structure 1212 is concave-convex from the center to outside of the each convex moth eye structure 1212, which is not limited herein.

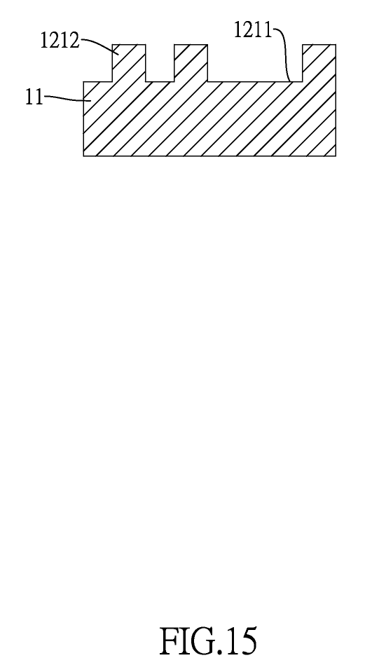

Please refer to FIG. 15, the moth eye structures 121 are used for recording in an optical disk or other storage media, the moth eye structures 121 represent data. In an embodiment, the substrate 11 is the optical disk, a plurality of the moth eye structures 121 of the moth eye portion 12 are formed on the first surface of the substrate 11 in a predetermined arrangement, and the moth eye portion 12 includes the concave moth eye structures 1211 and the convex moth eye structures 1212, which is not limited herein.

In an embodiment, the convex moth eye structures 1212 represent number “1”, the concave moth eye structures 1211 represent number “0”, and vice versa. As shown in FIG. 15, the moth eye structures 121 represent data “01010001”, which is not limited herein.

The concave moth eye structures 1211 or the convex moth eye structures 1212 are formed on the first surface of the substrate 11 in a predetermined arrangement to represent the data stored in the optical disk. Further, when the first surface of the substrate 11 is used as the touch surface of a touch device, a plurality of moth eye structures formed on the first surface of the substrate 11 is in a predetermined arrangement to represent data, then the data is used for information identification or a personal password for security, which is not limited herein.

In addition, due to fine particles of the moth eye structures 121 manufactured by the nanoimprint lithography method, in comparison with that of conventional same-sized storage media, the moth eye structures 121 can store more data when used for recording in an optical disk or other storage media, and thus a storage capacity of the storage media is improved. In an embodiment, the first surface of the substrate 11 further includes a phase change material layer, and then the storage media can write the data repeatedly via a thermal change way. In an embodiment, a phase change material is a germanium-antimony-tellurium alloy, which is not limited herein.

In sum, the moth eye structures 121 and the substrate 11 are integrally formed, and thus the hardness of the moth eye structures 121 and the substrate 11 are the same. Consequently, the moth eye structures 121 include the same hardness as the substrate 11, and the moth eye structures 121 are not easily damaged when touched by the users. Unlike conventional moth eye structures formed by the photoresist after exposing and hardening, the moth eye structures in embodiments include high abrasion scrape resistance can be used as the touch surface of the touch display panel for touching directly, the smooth of the touch surface is improved due to less friction.

Although the invention has been disclosed with reference to certain preferred embodiments thereof, the disclosure is not for limiting the scope. Persons having ordinary skill in the art may make various modifications and changes without departing from the spirit and the scope of the invention. Therefore, the scope of the appended claims should not be limited to the description of the preferred embodiments described above.

What is claimed is:

1. A method of manufacturing a substrate with moth eye structures, comprising the following steps:
providing a substrate having a first surface and a second surface; and
forming a plurality of moth eye structures on the first surface.

2. The method according to claim 1, wherein the moth eye structures on the first surface are manufactured by the following steps:
imprinting a photoresist layer to form a plurality of moth eye structure patterns on the photoresist layer and exposing the moth eye structure patterns;
etching the first surface;
removing the photoresist layer from the substrate to form the moth eye structures on the first surface.

3. The method according to claim 1, wherein the moth eye structures on the first surface are manufactured by the following step:
laser etching the first surface to form the moth eye structures.

4. The method according to claim 1, wherein the moth eye structures are used for representing data.

5. The method according to claim 1, wherein the substrate is a transparent substrate including aluminium oxide (AlₘOₙ), and m, n are natural numbers.

6. The method according to claim 1, wherein a phase change material layer is disposed on the first surface of the substrate.

7. The method according to claim 1, wherein sizes of the moth eye structures are between 200 nm and 300 nm.

8. A substrate with moth eye structures, comprising:
a substrate, including a first surface and a second surface, wherein the first surface includes a plurality of moth eye structures, and a material of the substrate and the moth eye structures are the same.

9. The substrate with moth eye structures according to claim 8, wherein the second surface further includes the moth eye structures.

10. The substrate with moth eye structures according to claim 8, wherein sizes of the moth eye structures are between 200 nm and 300 nm.

11. The substrate with moth eye structures according to claim 8, wherein the substrate is a transparent substrate including aluminium oxide (AlₘOₙ), and m, n are natural numbers.

12. The substrate with moth eye structures according to claim 8, wherein a phase change material layer is disposed on the first surface of the substrate.
